(19) United States
(12) Patent Application Publication
(10) Pub. No.: US 2024/0338514 A1
(43) Pub. Date: Oct. 10, 2024

(54) INFORMATION MANAGEMENT SYSTEM, SERVER DEVICE AND NON-TRANSITORY COMPUTER-READABLE STORAGE MEDIUM

(71) Applicant: SEIKO EPSON CORPORATION, Tokyo (JP)

(72) Inventor: Yusuke YAMADA, Shiojiri-shi (JP)

(21) Appl. No.: 18/626,861

(22) Filed: Apr. 4, 2024

(30) Foreign Application Priority Data
Apr. 6, 2023 (JP) 2023-061923
Dec. 11, 2023 (JP) 2023-208304

(51) Int. Cl. G06F 40/123; G06F 16/957; G06F 40/103; G06F 40/166; G06F 40/194; G06F 40/197

(52) U.S. Cl. CPC G06F 40/123; G06F 16/9577; G06F 40/103; G06F 40/166; G06F 40/194; G06F 40/197

(57) ABSTRACT

An information management system includes a first terminal device, and a server device, wherein the first terminal device includes a wireless communication I/F that acquires first data from the server device, a touch panel that receives an operation, and a first controller that transmits, when the touch panel receives an editing operation on the acquired first data, edit data corresponding to the editing operation to the server device, and wherein the server device includes a server communication I/F that acquires the edit data from the first terminal device, a server storage unit that stores the first data and the edit data in association with each other, and a server controller that provides a user with second data obtained by editing the first data stored in the server storage unit in accordance with the edit data.

The present application is based on, and claims priority from JP Application Serial Number 2023-061923, filed Apr. 6, 2023 and JP Application Serial Number 2023-208304, filed Dec. 11, 2023, the disclosures of which are hereby incorporated by reference herein in their entirety.

### BACKGROUND

### 1. Technical Field

The present disclosure relates to an information management system, a server device, and a non-transitory computer-readable storage medium.

### 2. Related Art

In the related art, systems are known in which data such as document files is stored on a server on a network. For example, JP-A-2003-141020 discloses an information storage output system that stores predetermined storage data in a storage server on a network. This information storage output system includes a remote output terminal, a remote output server, and an output request communication terminal. The remote output terminal outputs the supply data in a predetermined output format. The remote output server has the function of supplying at least supply data to the remote output terminal. The output request communication terminal transmits a primary output request for storage data to the storage server or the remote output server via the network. The remote output terminal outputs the storage data in response to the primary output request.

Assume that data stored in a server is downloaded to a first terminal device, the downloaded data is edited by the first terminal device, and the edited data is shared with a second terminal device. In this case, the first terminal device and the second terminal device are required to be connected by short-range wireless communication or coupled by a wired cable such as USB, and there is room for improvement in usability.

### SUMMARY

According to an aspect of the present disclosure, an information management system including a first terminal device, and a server device, wherein the first terminal device includes a first communication unit that acquires first data from the server device, an operation unit that receives an operation, and a first controller that transmits, when the operation unit receives an editing operation on the acquired first data, edit data corresponding to the editing operation to the server device, and wherein the server device includes a server communication unit that acquires the edit data from the first terminal device, a storage unit that stores the first data and the edit data in association with each other, and a server controller that provides a user with second data obtained by editing the first data stored in the storage unit in accordance with the edit data.

According to another aspect of the present disclosure, a server device including a server communication unit that acquires, from a first terminal device, edit data corresponding to an editing operation performed by the first terminal device on first data, a storage unit that stores the first data and the edit data in association with each other, and a server controller that provides a user with second data obtained by editing the first data stored in the storage unit in accordance with the edit data.

According to still another aspect of the present disclosure, a non-transitory computer-readable storage medium storing a program, the program causing a terminal device to execute an acquisition function of acquiring, from a server, first data stored in a server and edit data corresponding to an editing operation performed by a first terminal device on the first data, and a presentation function of generating second data obtained by editing the first data in accordance with the edit data to present the generated second data to a user.

### BRIEF DESCRIPTION OF THE DRAWINGS

FIG. 1 is a system configuration diagram of an information management system.

FIG. 2 is a diagram showing an example of the configuration of a user management database.

FIG. 3 is a diagram showing an example of the configuration of a registration file database.

FIG. 4 is a diagram showing an example of a list screen.

FIG. 5 is a diagram showing an example of a selection page screen.

FIG. 6 is a flowchart showing the operation of a server device when receiving a request for uploading a PDF file.

FIG. 7 is a flowchart showing the operation of a server controller when receiving PDF edit data.

FIG. 8 is a flowchart showing the operation of the server controller when receiving a request for viewing a PDF file.

FIG. 9 is a flowchart showing the operation of a first terminal device.

FIG. 10 is a flowchart showing the operation of a second terminal device.

### DESCRIPTION OF EMBODIMENTS

Embodiments will be described below with reference to the accompanying drawings.

### 1. System Configuration

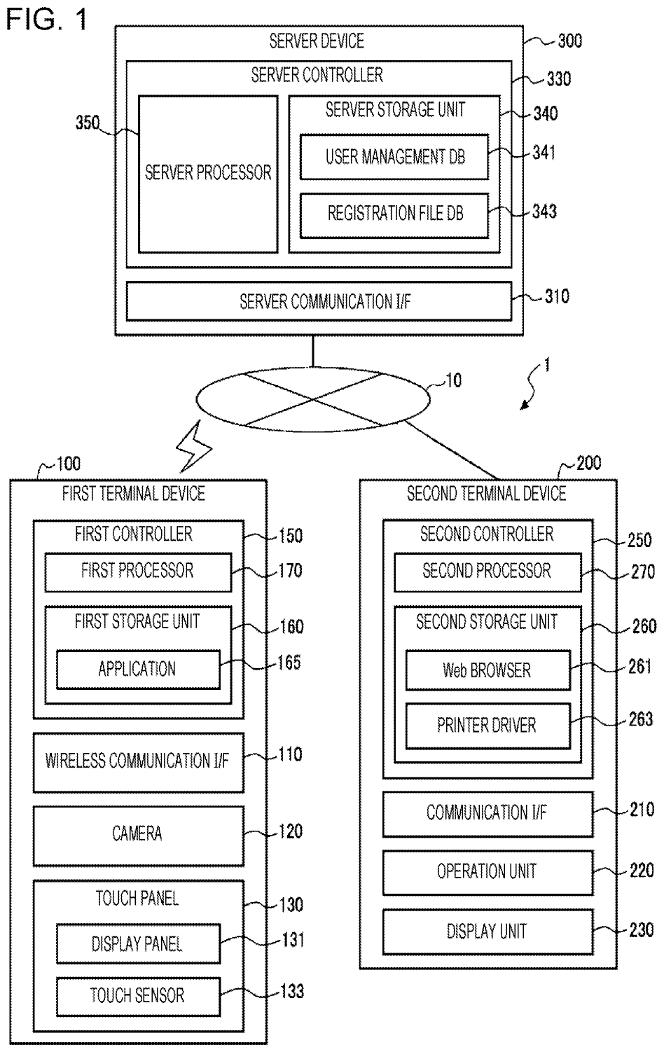

FIG. 1 is a system configuration diagram of an information management system 1. The information management system 1 includes a first terminal device 100, a second terminal device 200, and a server device 300, and has a configuration in which these devices are connected to each other via a network 10 so as to be capable of data communication. FIG. 1 shows an example in which the first terminal device 100 is connected to the network 10 wirelessly, and the second terminal device 200 is connected to the network 10 by wire. However, the connection form between the first terminal device 100 and the second terminal device 200, and the network 10 is not limited to the above, and the first terminal device 100 may be connected to the network 10 by wire, and the second terminal device 200 may be connected to the network 10 wirelessly.

### 2. Configurations of First Terminal Device and Second Terminal Device

Next, the configurations of the first terminal device 100 and the second terminal device 200 will be described. The first terminal device 100 includes a wireless communication I/F 110, a camera 120, a touch panel 130, and a first controller 150.

The wireless communication I/F 110 includes a network card (not shown) and performs wireless communication using a wireless local area network (LAN). The wireless communication I/F 110 of the present embodiment performs wireless communication using Wi-Fi. Wi-Fi is a registered trademark. The wireless communication I/F 110 corresponds to a first communication unit.

The camera 120 includes an imaging lens and an imaging element such as a charge coupled device (CCD) or a complementary MOS (CMOS), and generates a captured image according to instructions from the first controller 150. The camera 120 outputs the generated captured image to the first controller 150.

The touch panel 130 includes a display panel 131 and a touch sensor 133. The display panel 131 includes, for example, a liquid crystal panel or an organic electro-luminescence (EL) panel. Touch sensor 133 detects a user's touch operation on the display panel 131. When detecting a touch operation, the touch sensor 133 outputs information indicating the position of the detected touch operation to the first controller 150. A coordinate system is set in advance on the display panel 131, and when detecting a touch operation, the touch sensor 133 outputs coordinates indicating the position of the touch operation in this coordinate system to the first controller 150 as information indicating the position. The touch panel 130 corresponds to an operation unit.

The first controller 150 is a computer device including a first storage unit 160 and a first processor 170.

The first storage unit 160 includes a volatile memory and a nonvolatile memory. The volatile memory is configured by, for example, a random access memory (RAM). The nonvolatile memory is configured by, for example, a read-only memory (ROM), a flash memory, an electrically erasable programmable read-only memory (EEPROM), or the like.

The volatile memory is used as a calculation area of the first processor 170. The nonvolatile memory stores an OS, an application program 165, setting data, and the like. Hereinafter, the application program 165 will be abbreviated as an application 165.

The first processor 170 is an arithmetic processing device that includes a processor such as a central processing unit (CPU) and a micro-processing unit (MPU). The first processor 170 may be composed of a single processor or may be composed of a plurality of processors. Further, the first processor 170 may be configured by a system-on-a-chip (SoC) that is integrated with part or all of the first storage unit 160 and other circuits. Further, the first processor 170 may be configured by a combination of a CPU that executes a program and a digital signal processor (DSP) that executes predetermined arithmetic processing. Furthermore, the first processor 170 may have a configuration in which all of the functions of the first processor 170 are implemented in hardware, or may be configured using a programmable device.

Next, the configuration of the second terminal device 200 will be described. The second terminal device 200 includes a communication I/F 210, an operation unit 220, a display unit 230, and a second controller 250.

The communication I/F 210 includes a connector and an interface circuit, and is connected to the network 10 by wire. The communication I/F 210 includes, for example, a network interface card (NIC). The communication I/F 210 corresponds to a second communication unit.

The operation unit 220 includes input devices such as a mouse and a keyboard, receives user operations input through these input devices to output an operation signal corresponding to the received operations to the second controller 250.

The display unit 230 includes a display panel such as a liquid crystal panel or an organic EL panel, and displays characters, figures, images, and the like under the control of the second controller 250.

The second controller 250 is a computer device including a second storage unit 260 and a second processor 270.

The second storage unit 260 includes a volatile memory and a nonvolatile memory. The volatile memory is configured by, for example, a RAM. The nonvolatile memory is configured of, for example, a ROM, a flash memory, an EEPROM, or the like.

The volatile memory is used as a calculation area of the second processor 270. The nonvolatile memory stores a control program, a World Wide Web (Web) browser 261, and a printer driver 263.

The second processor 270 is an arithmetic processing device including a processor such as a CPU or an MPU. The second processor 270 may be composed of a single processor or may be composed of a plurality of processors. Further, the second processor 270 may be configured by an SoC that is integrated with part or all of the second storage unit 260 and other circuits. Furthermore, the second processor 270 may be configured by a combination of a CPU that executes a program and a DSP that executes predetermined arithmetic processing. Further, the second processor 270 may have a configuration in which all of the functions of the second processor 270 are implemented in hardware, or may be configured using a programmable device.

### 3. Server Device Configuration

The server device 300 includes a server communication I/F 310 and a server controller 330.

The server communication I/F 310 includes a connector and an interface circuit, and is connected to the network 10 by wire. The server communication I/F 310 includes, for example, a NIC as an interface circuit. The server communication I/F 310 corresponds to a server communication unit.

The server controller 330 is a computer device including a server storage unit 340 and a server processor 350. The server storage unit 340 corresponds to a storage unit.

The server storage unit 340 includes a volatile memory, a nonvolatile memory, and an auxiliary storage device. The volatile memory is configured by, for example, a RAM. The nonvolatile memory is configured of, for example, a ROM, a flash memory, an EEPROM, or the like. The auxiliary storage device is configured by a solid state drive (SSD), a hard disk drive (HDD), or the like.

The volatile memory is used as a calculation area of the server processor 350. The nonvolatile memory stores a control program, a user management database 341, and a registration file DB 343. Hereinafter, the database may be abbreviated as DB.

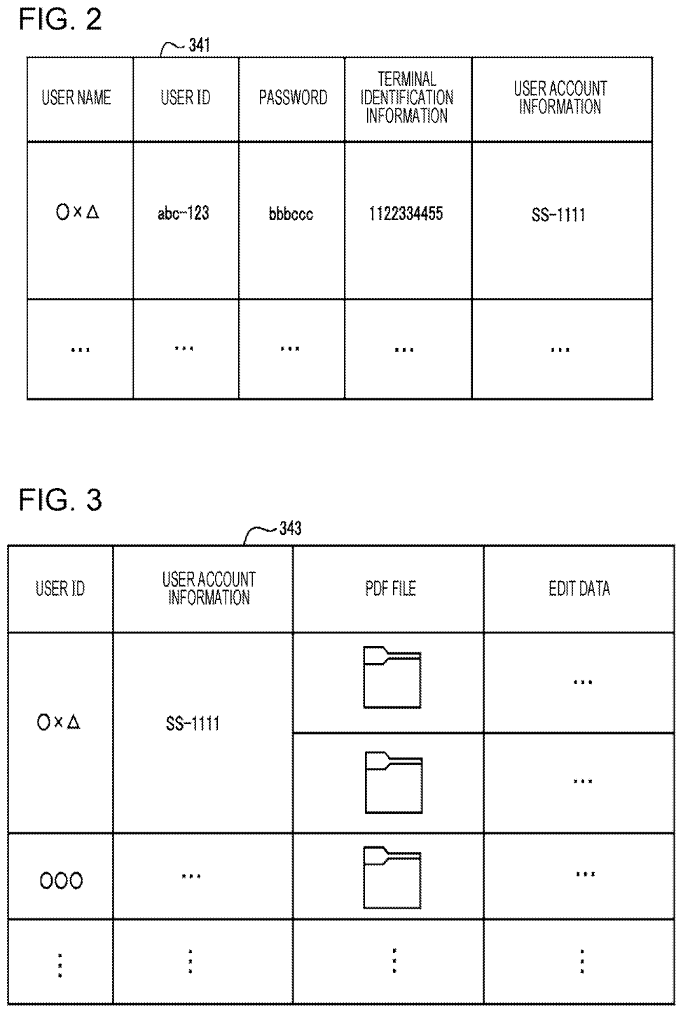

FIG. 2 is a diagram showing an example of the configuration of the user management DB 341. The user management DB 341 is a database that manages registration information about a user registered in the information management system 1. One record of the user management DB 341 includes a user name, a user ID and a password, a terminal identification information, and a user account information. The user name, the user ID, and the password are authentication information set by the user.

The terminal identification information is identification information that identifies a terminal device that will push distribute a portable document format (PDF) file when the PDF file is uploaded to the server device 300. When the user does not desire push distribution of the PDF file, the user does not register the terminal identification information in the terminal identification information field of the user management DB 341. Further, information about the terminal registered in the terminal identification information is not limited to the identification information about one terminal device, but it is also possible to register the identification information about a plurality of terminal devices. Further, the information about the terminal registered in the terminal identification information is not limited to the terminal devices owned by the users whose usernames are registered in the same record. For example, identification information about the terminal devices each owned by a plurality of members of a group to which the users belong may be registered. Although it goes without saying that the document file to be uploaded is not limited to a PDF file, the following description will be made assuming that the document file to be uploaded is a PDF file. Note that, when downloaded from the server device 300 to the second terminal device 200 or viewed by the second terminal device 200, which will be described later, all files are PDF files. It is also possible to register the terminal identification information in the user management DB 341 separately for each group. For example, it is also possible to separately register in the user management DB 341 terminal identification information for identifying the terminal devices owned by users belonging to group A and terminal identification information for identifying terminal devices owned by users belonging to group B.

User account information is information generated by the server device 300, and is information that is required to be input when viewing or editing a push distributed PDF file. User account information is registered in the server device 300 on a user-by-user basis, and a privileged user and a general user can be identified from the user account information. The privileged user can view all files of other regular users. As described above, it is possible to register identification information about a terminal device owned by a user other than the user who registered the PDF file in the server device 300 as the terminal identification information. For this reason, for example, when attempting to view a PDF file that has been push distributed to the first terminal device 100, the first terminal device 100 requests input of user account information, so that only users who are permitted to view the file can view the PDF file. The user who has registered the PDF file in the server device 300 notifies the user who is permitted to view or edit the PDF file of the user account information in advance by e-mail or the like to.

FIG. 3 is a diagram showing an example of the configuration of the registration file DB 343. The registration file DB 343 is a database that manages PDF files uploaded to the server device 300 for each user. One record of the registration file DB 343 includes a user ID, user account information, a PDF file, and edit data.

The user account information is not necessary information when viewing a PDF file created by the user on a terminal device owned by the user, so registration in the registration file DB 343 is not necessary. Furthermore, for the user account information, it is also possible to register a plurality of pieces of user account information under one user ID. For example, assume that a user belongs to two groups, group A and group B. In this case, it is also possible to register separate user account information for the file that is allowed to be viewed by the user belonging to group A and the file that is allowed to be viewed by the user who belong to group B.

A PDF file registered in the registration file DB 343 includes identification information for identifying this PDF file. The edit data includes difference data and position information. The edit data is data obtained by editing a PDF file by the server device 300. The difference data indicates the difference between the PDF file before editing and the PDF file after editing, and includes, for example, at least one of a text, a figure, and an image. The position information is information indicating the position of the PDF file where the difference data is placed. For example, assume that a PDF file is push distributed to the first terminal device 100, and the user of the first terminal device 100 adds a handwritten memorandum or the like to the third page of the push distributed PDF file. In this case, the difference data is handwritten memorandum data, and the position information is information indicating page 3 of the PDF file.

The server processor 350 is an arithmetic processing device including a processor such as a CPU or an MPU. The server processor 350 may be composed of a single processor or may be composed of a plurality of processors. Further, the server processor 350 may be configured by an SoC that is integrated with part or all of the server storage unit 340 and other circuits. Further, the server processor 350 may be configured by a combination of a CPU that executes a program and a DSP that executes predetermined arithmetic processing. Further, the server processor 350 may have a configuration in which all of the functions of the server processor 350 are implemented in hardware, or may be configured using a programmable device.

### 4. Operation of Information Management System

In the information management system 1 of the present embodiment, a user uploads a file generated by operating the second terminal device 200 to the server device 300 as first data, and registers the uploaded file in the server device 300. When an application program is selected by the user's operation, the second controller 250 of the second terminal device 200 executes the application program and generates a document file including at least one of a text, a figure, and a captured image according to the user's operation of the operation unit 220.

When the operation unit 220 receives an operation of requesting uploading of the generated document file to the server device 300, the second controller 250 activates the Web browser 261 and accesses the Website provided by the server device 300. Note that the Web browser 261 is activated only the first time, and thereafter, the login information is stored in the Windows credential manager, so that the Web browser 261 is not activated. Windows is a registered trademark.

When the second controller 250 accesses the Website, the second controller 250 transmits the user ID and the password input by the user to the server device 300 in accordance with a request for inputting the user ID and the password displayed on the Website. Thereafter, the second controller 250 acquires user account information from the server device 300. Note that instead of the Web browser 261, a dedicated application may be used to acquire the user account information from the server device 300. The file uploaded to the server device 300 may be allowed to be viewed or edited by a third party. Therefore, user account information is acquired from the server device 300, and the acquired user account information and the PDF file are registered in the server device 300 in association with each other. By notifying a third party authorized to view or edit the PDF file of this user account information in advance, the third party can also view or edit the PDF file.

The second controller 250 executes the printer driver 263 to convert the file to a PDF file, and uploads the converted PDF file and the user account information to the server device 300.

When the server controller 330 of the server device 300 receives the PDF file and the user account information uploaded from the second terminal device 200, the server controller 330 registers the received PDF file and the received user account information in the registration file DB 343 in association with each other, and stores the registered PDF file and the registered user account information in the server storage unit 340. Further, the server controller 330 registers the received user account information in association with the corresponding user ID in the user management DB 341. This user ID is a user ID received from the second terminal device 200.

Next, the server controller 330 determines whether push distribution is set for the user ID received from the second terminal device 200. The server controller 330 refers to the registration file DB 343 and determines that push distribution is set when the user account information is registered in association with the received user ID. When push distribution is set for the corresponding user ID, the server controller 330 acquires terminal identification information that identifies the distribution destination to which the PDF file is to be push distributed. The server controller 330 push distributes the PDF file and the identification information for identifying the PDF file to the terminal device corresponding to the acquired terminal identification information. Furthermore, instead of push distributing the PDF file, the server controller 330 may transmit a message making a notification that the PDF file has been registered in the server device 300 or that the PDF file has been updated as push distribution to the first terminal device 100 indicated by the terminal identification information. For example, upon receiving the PDF file from the second terminal device 200, the server controller 330 may transmit a message making a notification that the PDF file has been registered in the server device 300, or that the PDF file has been updated as push distribution to the first terminal device 100 indicated by the terminal identification information. Furthermore, when there is a plurality of logged-in users, the PDF file and the identification information about the PDF file may be automatically push distributed to terminal devices of respective users.

Next, the operation of the first terminal device 100 that receives push distribution of the PDF file and the identification information about the PDF file will be described. The PDF file that the first terminal device 100 receives from the server device 300 corresponds to first data. Upon receiving the push distribution, the first controller 150 displays on the touch panel 130 that the push distribution has been received. When receiving an operation requesting to display a PDF file, the first controller 150 may display a display requesting input of user account information on the touch panel 130. By requesting input of user account information when push distributing PDF files, it is possible to reduce the possibility of information leakage. When the user account information is input through a touch operation, the first controller 150 activates the application 165 and displays the push distributed PDF file on the touch panel 130. The user can perform operations such as adding a handwritten memorandum, or adding a new document, an image, an image captured by the camera 120, and the like on the PDF file displayed on the touch panel 130.

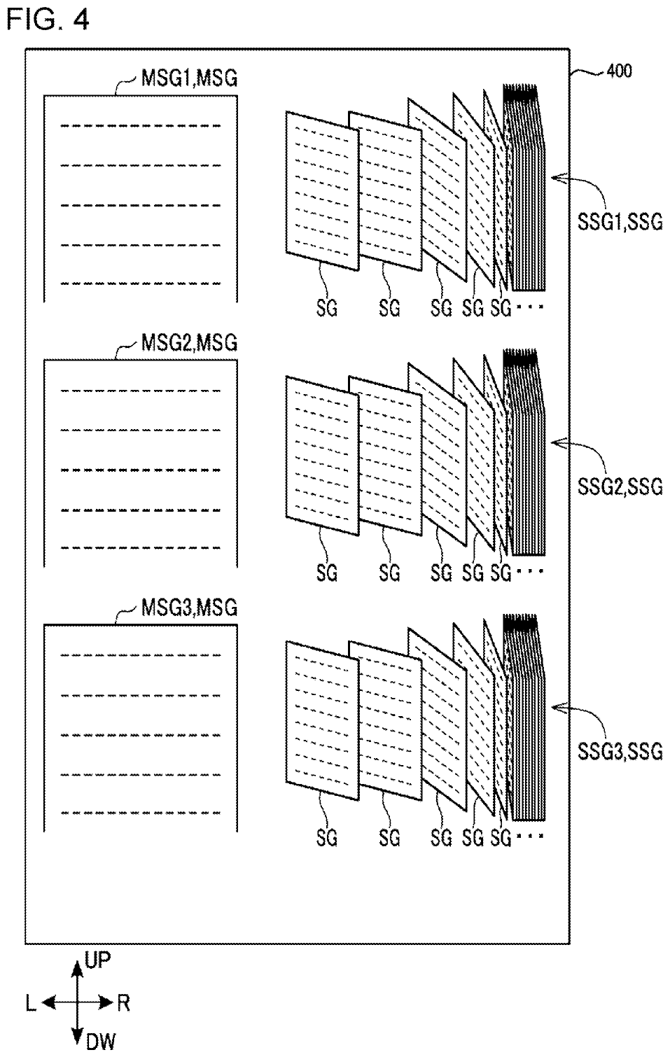

FIG. 4 is a diagram showing an example of a list screen 400 displayed on the touch panel 130 of the first terminal device 100. The first controller 150 activates the application 165 and displays the push distributed PDF file on the touch panel 130. The list screen 400 shown in FIG. 4 is displayed on the touch panel 130. The list screen 400 displays a combination of a thumbnail image group SSG and a main thumbnail image MSG for each PDF file. In the following description, the thumbnail image group SSG of the n-th PDF file is indicated as an n-th thumbnail image group SSGn. The main thumbnail image MSG of the n-th PDF file is indicated as an n-th main thumbnail image MSGn. n is an integer of 1 or more.

The list screen 400 shown in FIG. 4 displays a combination of a first thumbnail image group SSG1 and a first main thumbnail image MSG1 at a predetermined position based on the first PDF file. The list screen 400 displays a combination of a second thumbnail image group SSG2 and a second main thumbnail image MSG2 based on the second PDF file. The combination of the second thumbnail image group SSG2 and the second main thumbnail image MSG2 is displayed below the combination of the first thumbnail image group SSG1 and the first main thumbnail image MSG1. The list screen 400 displays a combination of a third thumbnail image group SSG3 and a third main thumbnail image MSG3 based on the third PDF file. The combination of the third thumbnail image group SSG3 and the third main thumbnail image MSG3 is displayed below the combination of the second thumbnail image group SSG2 and the second main thumbnail image MSG2.

The thumbnail image group SSG is an image group in which a plurality of thumbnail images SG is disposed in the left-right direction. Each of the thumbnail images SG included in the thumbnail image group SSG is displayed in a bird's-eye view from a predetermined viewpoint. One thumbnail image SG included in the thumbnail image group SSG corresponds to one page of the document indicated by the corresponding PDF file.

The main thumbnail image MSG is a thumbnail image SG corresponding to a representative page of the PDF file. An example of the representative page is the top page of the PDF file. The list screen 400 may display part of the thumbnail image SG of a predetermined page as the main thumbnail image MSG, or may display all of the thumbnail image SG of a predetermined page as the main thumbnail image MSG.

On the list screen 400, a combination of the thumbnail image group SSG and the main thumbnail image MSG can be selected by a touch operation. When the combination is selected on the list screen 400, the first controller 150 displays a selection page screen 500 regarding the selected PDF file.

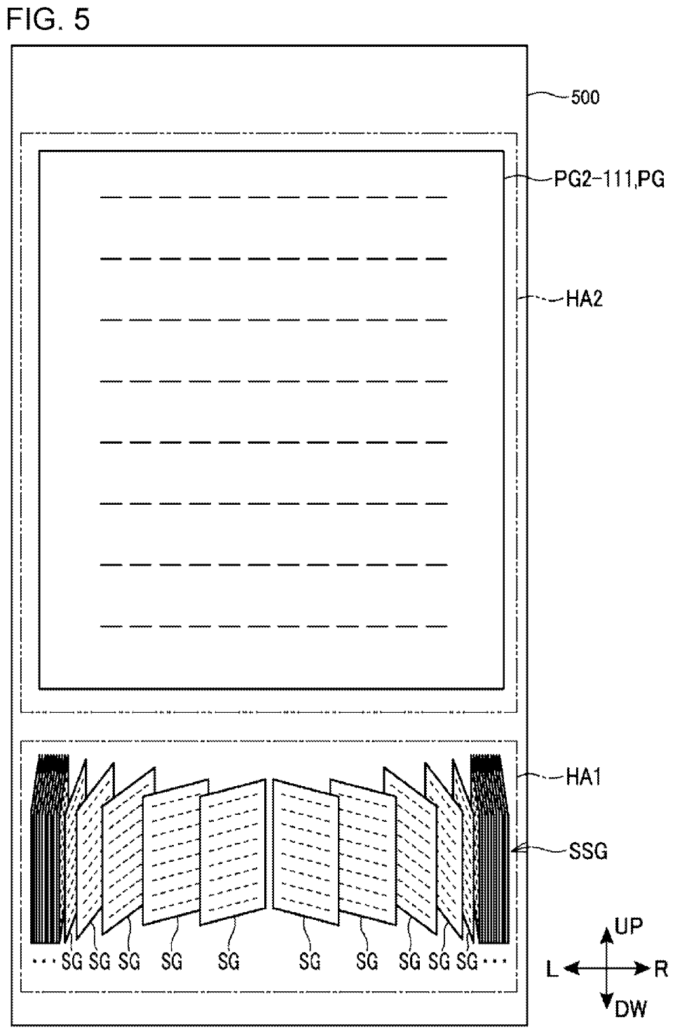

FIG. 5 is a diagram showing an example of the selection page screen 500. The selection page screen 500 displays a thumbnail image group display area HA1 and a page image display area HA2. The thumbnail image group display area HA1 is an area in which the thumbnail image group SSG selected on the list screen 400 is displayed. When a combination of the first main thumbnail image MSG1 and the first thumbnail image group SSG1 is selected on the list screen 400, the thumbnail image group display area HA1 shows the first thumbnail image group SSG1 included in the selected combination.

The first controller 150 changes the display mode of the thumbnail image group SSG by performing a predetermined touch operation such as a flick operation or a slide operation with an indicator such as a finger in the thumbnail image group display area HA1.

When a slide operation to the right is performed, the thumbnail image SG moves from the left to the right in the thumbnail image group display area HA1 according to the amount of rightward movement of the indicator. When a slide operation to the left is performed, the thumbnail image SG moves from the right to the left in the thumbnail image group display area HA1 according to the amount of leftward movement of the indicator.

The page image display area HA2 is an area where a page image PG of a page corresponding to the thumbnail image SG selected in the thumbnail image group display area HA1 is displayed. In the following description, the page image PG corresponding to the m-th page of the document indicated by the n-th PDF file is indicated by a number n-m following the symbol PG. m is an integer of 1 or more. A page image PG2-111 shown in FIG. 5 shows the page image PG corresponding to the 111-th page of the document indicated by the second PDF file.

The page image display area HA2 receives a switching operation by a predetermined touch operation from the user. Examples of the predetermined touch operation include a flick operation and a slide operation. The switching operation corresponds to an example of a first operation. When the first controller 150 receives a switching operation in the page image display area HA2, the first controller 150 switches the page image PG to be displayed.

When a predetermined touch operation to the right is performed in the page image display area HA2, the page image PG of the page before the page corresponding to the page image PG displayed before the switching operation is displayed in the page image display area HA2. When a predetermined touch operation to the left is performed in the page image display area HA2, the page image PG of the page after the page corresponding to the page image PG displayed before the switching operation is displayed in the page image display area HA2.

When a slide operation to the right is performed in the state of FIG. 5, a page image PG2-110 is displayed in the page image display area HA2. When a sliding operation to the left is performed in the state of FIG. 5, a page image PG2-112 is displayed in the page image display area HA2.

When the page image PG in the page image display area HA2 is switched, the display mode of the thumbnail image group SSG changes in the thumbnail image group display area HA1, and the thumbnail image SG corresponding to the page image PG after switching is generally centrally located in the left-right direction.

The user can add a handwritten memorandum to the page image PG or add a captured image captured by the camera 120 of the first terminal device 100 to the PDF file by performing a touch operation on the page image PG. The operation such as adding a handwritten memorandum or adding a captured image to a PDF file correspond to an editing operation. The first controller 150 adds a handwritten memorandum and a captured image to the PDF file based on the editing operation. The data format of the handwritten memorandum and the captured image added to the PDF file is, for example, data in a proprietary format provided by a business providing the application 165. A business that provides the application 165 is simply referred to as a provider.

The first controller 150 generates edit data every time a preset operation is detected. The edit data includes difference data and position information. The data format of the edit data may be PDF, or may be data in a proprietary format provided by the provider. When the data format of the edit data is data in a proprietary format provided by the provider, the first controller 150 converts the data format of the generated edit data into PDF. The edit data converted into the PDF format is referred to as PDF edit data. The first controller 150 transmits the converted PDF edit data and the identification information about the PDF file received from the server device 300 to the server device 300.

The difference data is additional data added to the PDF file by the user's editing operation. That is, when the PDF edit data has not been transmitted to the server device 300, the difference data is data indicating a difference between the PDF file received by push distribution from the server device 300 and the PDF file added by the editing operation before a preset operation is detected. In addition, when PDF edit data has been transmitted to the server device 300, the difference data is data indicating a difference between the PDF file immediately after the PDF edit data was last transmitted to the server device 300, and the PDF file changed before the preset operation is detected.

Further, the position information is information indicating the page of the PDF file where a difference has occurred due to the user's operation, and the position within the page. For example, assume that a new page is added between pages 5 and 6 of a PDF file by a user operation. In this case, the difference data is data of the added page, and the position information is data indicating between page 5 and page 6.

Further, the preset operations include the following operations. First, when the first terminal device 100 has a handwriting mode that receives a handwriting operation using the touch panel 130, the operation of turning off the handwriting mode corresponds to the preset operation. In addition, when the first terminal device 100 does not have a handwriting mode that receives a handwriting operation using the touch panel 130 and characters, symbols, figures, and the like are drawn on the touch panel 130 using the virtual keyboard, the operation of ending the drawing mode and returning to the list screen 400 corresponds to the preset operation. In other words, the operation of returning from the selection page screen 500 shown in FIG. 5 to the list screen 400 shown in FIG. 4 corresponds to the preset operation. In addition, for the preset operation, it may be determined that the preset operation has been detected when a set time has elapsed since contact between an indicator such as the user's finger or a touch pen and the touch panel 130 was no longer detected.

Furthermore, in the above description, the first controller 150 was described as transmitting PDF edit data including the difference data and the position information to the server device 300, but the configuration may be such that the modified PDF file is uploaded to the server device 300.

Upon receiving the PDF edit data uploaded by the first terminal device 100 and the identification information about the PDF file, the server controller 330 of the server device 300 registers the PDF edit data in the registration file DB 343. That is, the PDF edit data is registered in the registration file DB 343 as a change history. The server controller 330 registers the received PDF edit data as edit data in the record of the PDF file corresponding to the identification information among the records of the registration file DB 343. The PDF file, which is the first data, and the PDF edit data, which is the edit data in PDF format, are registered as separate files in the registration file DB 343.

Next, the server controller 330 acquires the PDF file and the PDF edit data registered in the registration file DB 343, and updates the PDF file based on the difference data and the position information included in the PDF edit data. The updated PDF file is referred to as an update PDF file. The update PDF file corresponds to second data. That is, the PDF file is updated to the same state as the PDF file displayed on the touch panel 130 of the first terminal device 100 and updated by the user's operation. Even after updating the PDF file based on the difference data and the position information, the server controller 330 continues to store the PDF file, which is the first data, and the edit data without deleting them from the server storage unit 340.

The server controller 330 provides the update PDF file, which is the second data, to the user. The server controller 330 provides the update PDF file to the user by transmitting the update PDF file from the server device 300 to the second terminal device 200. Alternatively, the server controller 330 provides the update PDF file to the user by the second terminal device 200 viewing the Web page of the update PDF file provided by the server controller 330. The user operates the second terminal device 200 to activate the Web browser 261 and accesses the Website provided by the server device 300. On the Web page displayed on the display unit 230 by the Web browser 261, an input field for authentication information is displayed. The user operates the operation unit 220 and inputs the user ID and the password into the input fields.

When the user ID and the password are input in the input field and the confirm button displayed on the Web page is pressed, the second controller 250 transmits the input user ID and the input password to the server device 300. The server controller 330 executes an authentication process by comparing the user ID and the password received from the second terminal device 200 with authentication information registered in the user management DB 341. When the received user ID and the received password match the authentication information registered in the user management DB 341, the server controller 330 determines that the authentication is successful, and displays the input field of the user account information on the Web page displayed on the display unit 230. The user operates the operation unit 220 and inputs the user account information into the input field.

The second controller 250 transmits the input user account information to the server device 300. The server controller 330 transmits, to the second terminal device 200, data of the Web page that shows a list screen of the files each associated with the received user account information. As a result, a list screen of the files each associated with the user account information is displayed on the display unit 230 of the second terminal device 200.

The user inputs selection of a file from the list screen displayed on the Web page and the designation of the process to be performed on the update PDF file. The process includes a viewing request, downloading, printing, and the like. In accordance with the operation received by the operation unit 220, the second controller 250 transmits, to the server device 300, an instruction including file selection information and designation of a process to be performed on the file. When the server controller 330 receives an instruction from the second terminal device 200 and the received instruction is a viewing request, the server controller 330 displays the update PDF file corresponding to identification information on the Web page displayed on the display unit 230 of the second terminal device 200 in accordance with the instruction. The server controller 330 may generate the update PDF file when a viewing request is received from the second terminal device 200. Upon receiving the viewing request, the server controller 330 generates the update PDF file and displays the generated update PDF file on a Web page.

Furthermore, when the instruction received from the second terminal device 200 is to download, the server controller 330 may provide the update PDF file to the user by transmitting the update PDF file to the second terminal device 200 in accordance with this instruction. Note that when using a dedicated viewer that operates on the Web browser 261, files in a format other than that of the update PDF file can be downloaded.

Further, the update PDF file may be push distributed to the second terminal device 200. The server controller 330 determines whether push distribution is set for the user ID of the logged-in user. The server controller 330 refers to the registration file DB 343 and determines that push distribution is set when the user account information is registered in association with the user ID of the logged-in user. When push distribution is set for the corresponding user ID, the server controller 330 acquires the terminal identification information that identifies the distribution destination to which the PDF file is to be push distributed. The server controller 330 push distributes the PDF file the terminal device corresponding to the acquired terminal identification information. Furthermore, instead of push distributing the PDF file, the server controller 330 may transmit a message making a notification that the PDF file has been registered in the server device 300 or that the PDF file has been updated as push distribution to the first terminal device 100 indicated by the terminal identification information. Note that when there is a plurality of logged-in users, the PDF file may be automatically push distributed to terminal devices of respective users.

Further, without generate the update PDF file, which is the second data, the server controller 330 may transmit, to the second terminal device 200, the PDF file, which is the first data, and the PDF edit data, which is the edit data, according to the instruction from the second terminal device 200. The server controller 330 transmits the PDF file and the PDF edit data to the second terminal device 200, and causes the second terminal device 200 to generate an update PDF file, thereby providing the update PDF file to the user. When the Web browser 261 receives the PDF file and the PDF edit data, the second controller 250 of the second terminal device 200 causes the Web browser 261 to update the PDF file to based on the difference data and the position information included in the PDF edit data. The second controller 250 displays, on the display unit 230, the update PDF file updated and generated by the Web browser 261.

In addition, in response to the edit data being transmitted from the first terminal device 100, the server controller 330 may display, on the Web browser 261, the update PDF file that is the second data updated based on the transmitted edit data. For example, it is assumed that the user of the first terminal device 100 and the user of the second terminal device 200 are both logged in, and the terminal identification information about the second terminal device 200 is registered in the user ID of the user of the first terminal device 100. Upon receiving the PDF edit data from the first terminal device 100, the server controller 330 updates the PDF file based on the received PDF edit data, and generates an update PDF file, which is the second data. Further, the server controller 330 transmits the generated update PDF file to the second terminal device 200 every time an update is made, and displays the latest update PDF file on the Web browser 261 of the second terminal device 200.

The update PDF file, which is the second data, may be temporary for providing to the second terminal device 200. Therefore, the server controller 330 may delete the update PDF file, which is the second data, from the server storage unit 340 before the connection between the second terminal device 200 and the server device 300 is terminated, or may delete the update PDF file, which is the second data, from the server storage unit 340 in response to the connection between the second terminal device 200 and the server device 300 being terminated. The server controller 330 may stop protecting the update PDF file stored by the server storage unit 340 and overwrite the update PDF file with other data before the connection between the second terminal device 200 and the server device 300 is terminated, or in response to the connection between the second terminal device 200 and the server device 300 being terminated. Unlike the update PDF file, which is second data, the server controller 330 stores the PDF file, which is the first data, and the PDF edit data, which is the edit data, until the user explicitly gives a deletion instruct.

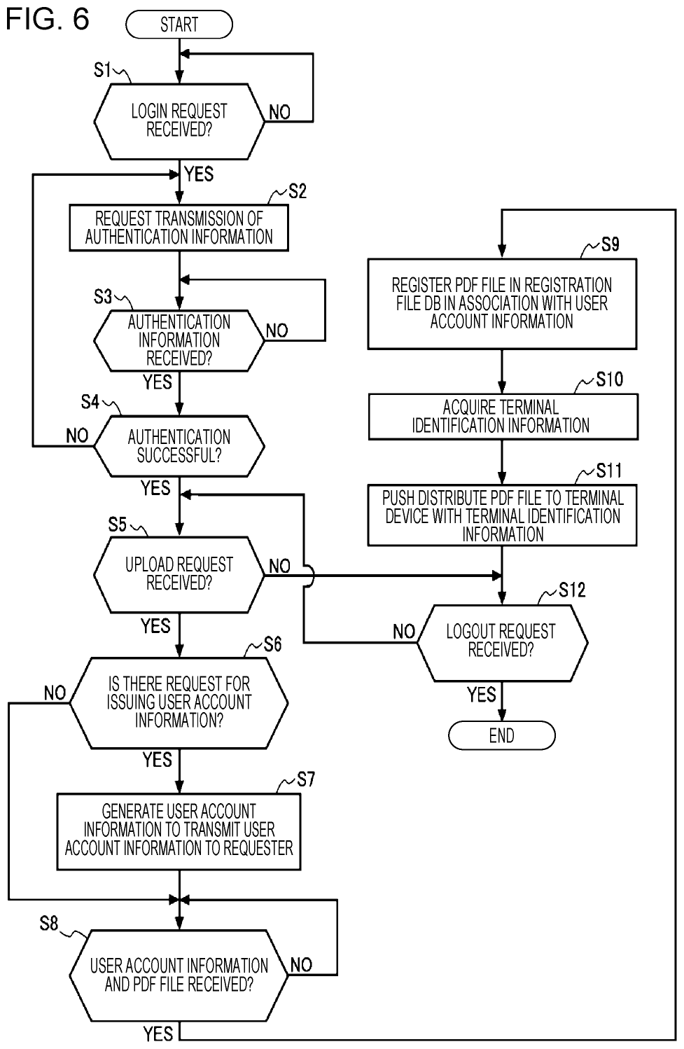

FIG. 6 is a flowchart showing the operation of the server device 300 when receiving a request for uploading the PDF file from the second terminal device 200. The operation of the server controller 330 will be described with reference to the flowchart shown in FIG. 6.

The server controller 330 first determines whether a login request has been received (step S1). When the server controller 330 has not received a login request (step S1/NO), the server controller 330 waits until the login request is received.

Upon receiving the login request (step S1/YES), the server controller 330 requests the second terminal device 200 that is the requester of the login request to transmit the user ID and the password that are authentication information (step S2). After that, the server controller 330 determines whether authentication information has been received from the second terminal device 200 (step S3).

When the server controller 330 has not received the authentication information from the second terminal device 200 (step S3/NO), the server controller 330 waits until the authentication information is received. Upon receiving the authentication information from the second terminal device 200 (step S3/YES), the server controller 330 collates the user ID and the password included in the received authentication information with the user ID and the password registered in the user management DB 341.

When the received user ID and the received password do not match the user ID and the password registered in the user management DB 341, the server controller 330 determines that the authentication has failed (step S4/NO). In this case, the server controller 330 returns the process to step S2 and requests the second terminal device 200 to retransmit the authentication information to the server controller 330. Furthermore, when the received user ID and the received password match the user ID and the password registered in the user management DB 341, the server controller 330 determines that the authentication is successful (step S4/YES). When determining that the authentication is successful, the server controller 330 determines whether a request for uploading a PDF file has been received from the second terminal device 200 (step S5).

When the server controller 330 has not received a request for uploading the PDF file from the requester (step S5/NO), the server controller 330 determines whether a logout request has been received (step S12). When the server controller 330 receives the logout request (step S12/YES), the server controller 330 executes the logout process and ends this process flow. Further, when the server controller 330 has not received a logout request (step S12/NO), the server controller 330 returns the process to the determination in step S5.

When the server controller 330 receives a request for uploading a PDF file from the second terminal device 200 (step S5/YES), the server controller 330 determines whether a request for issuing user account information has been received from the second terminal device 200 (step S6).

When the server controller 330 receives a request for issuing the user account information from the second terminal device 200 (step S6/YES), the server controller 330 generates the user account information and transmits the generated user account information to the second terminal device 200 as the requester (step S7). When the server controller 330 has not received a request for issuing the user account information from the second terminal device 200 (step S6/NO), the server controller 330 advance the process to the determination in step S8. In step S8, the server controller 330 determines whether the user account information and the PDF file have been received (step S8).

When the server controller 330 has not received the user account information or the PDF file (step S8/NO), the server controller 330 waits until the user account information and the PDF file are received. Upon receiving the user account information and the PDF file (step S8/YES), the server controller 330 generates a new record in the registration file DB 343, and registers the user account information issued in step S7 and the received PDF file in the generated record (step S9).

Next, the server controller 330 refers to the user management DB 341 and acquires the terminal identification information registered in association with the user ID of the user of the second terminal device 200 that is logged in (step S10). Upon acquiring the terminal identification information, the server controller 330 push distributes the PDF file received in step S8 and the identification information about this PDF file to the acquired terminal identification information (step S11).

Next, the server controller 330 determines whether a logout request has been received from the second terminal device 200 (step S12). When the server controller 330 receives the logout request (step S12/YES), the server controller 330 executes the logout process and ends this process flow. Further, when the server controller 330 has not received a logout request (step S12/NO), the server controller 330 returns the process to the determination in step S5.

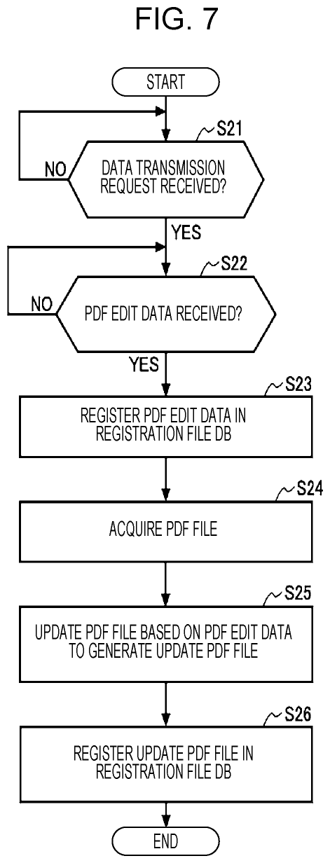

FIG. 7 is a flowchart showing the operation of the server controller 330 when the PDF edit data is received from the first terminal device 100. The operation of the server controller 330 will be described with reference to the flowchart shown in FIG. 7. Note that the flowchart shown in FIG. 7 will be described on the assumption that the terminal device that push distributed the PDF file in step S11 of the flowchart shown in FIG. 6 is the first terminal device 100.

First, the server controller 330 determines whether a data transmission request has been received from the first terminal device 100 (step S21). When the server controller 330 has not received a data transmission request (step S21/NO), the server controller 330 waits until the data transmission request is received.

Upon receiving the data transmission request (step S21/YES), the server controller 330 determines whether PDF edit data has been received from the first terminal device 100 that is the requester of the transmission request (step S22). When the server controller 330 has not received the PDF edit data (step S22/NO), the server controller 330 waits until the PDF edit data is received.

Upon receiving the PDF edit data (step S22/YES), the server controller 330 registers the received PDF edit data in the registration file DB 343 (step S23). The server controller 330 receives the PDF edit data and the identification information of the PDF file from the first terminal device 100. The server controller 330 registers the received PDF edit data as edit data in the record of the PDF file corresponding to the received identification information (step S23).

Next, the server controller 330 acquires the PDF file push distributed to the first terminal device 100 from the registration file DB 343 (step S24). Next, the server controller 330 updates the acquired PDF file based on the received PDF edit data to generate an update PDF file (step S25). The server controller 330 registers the generated update PDF file in the registration file DB 343 (step S26).

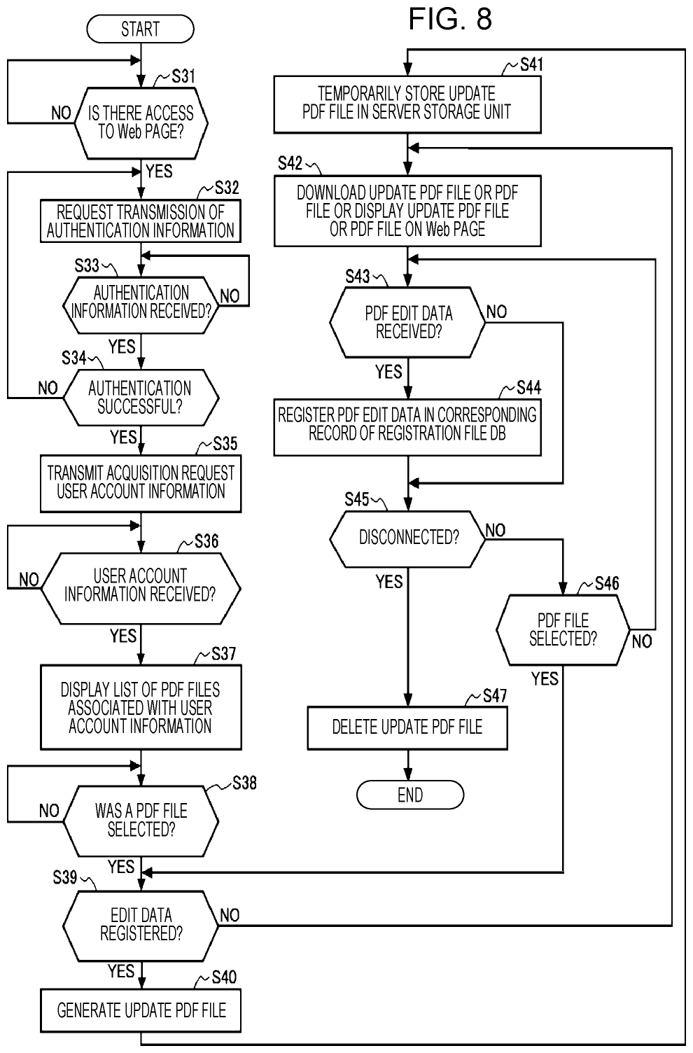

FIG. 8 is a flowchart showing the operation of the server controller 330 when receiving a request for viewing a PDF file. The operation of the server controller 330 will be described with reference to the flowchart shown in FIG. 8. The server controller 330 determines whether there is access to the Web page provided by the server device 300 (step S31). When there is no access to the Web page (step S31/NO), the server controller 330 waits until access to the Web page is received.

When the server controller 330 receives access to the Web page from the second terminal device 200 (step S31), the server controller 330 requests the second terminal device 200 from which the access was received to transmit a user ID and a password that are authentication information (step S32).

Next, the server controller 330 determines whether authentication information has been received from the second terminal device 200 (step S33). When the server controller 330 has not received the authentication information (step S33/NO), the server controller 330 waits until the authentication information is received.

Upon receiving the authentication information from the second terminal device 200 (step S33/YES), the server controller 330 collates the user ID and the password included in the received authentication information with the user ID and the password registered in the user management DB 341.

When the received user ID and the received password do not match the user ID and the password registered in the user management DB 341, the server controller 330 determines that the authentication has failed (step S34/NO). In this case, the server controller 330 returns the process to step S32 to request the second terminal device 200 to retransmit the authentication information to the server controller 330.

Furthermore, when the received user ID and the received password match the user ID and the password registered in the user management DB 341, the server controller 330 determines that the authentication is successful (step S34/YES). In this case, the server controller 330 transmits a user account information acquisition request to the second terminal device 200 (step S35).

The server controller 330 determines whether the user account information has been received from the second terminal device 200 (step S36), and when the user account information has not been received (step S36/NO), the server controller 330 waits until the user account information is received.

Upon receiving the user account information from the second terminal device 200 (step S36/YES), the server controller 330 displays a list of the PDF files associated with the received user account information on the display unit 230 of the second terminal device 200 (step S37).

Next, the server controller 330 determines whether one of the PDF files displayed in the list has been selected (step S38). When the one of the PDF files is not selected (step S38/NO), the server controller 330 waits until the PDF file is selected.

When the PDF file is selected (step S38/YES), the server controller 330 determines whether the edit data associated with the selected PDF file is registered in the registration file DB 343 (step S39).

When the edit data is registered in the registration file DB 343 (step S39/YES), the server controller 330 edits the PDF file with the edit data to generate an update PDF file (step S40). The server controller 330 temporarily stores the generated update PDF file in the server storage unit 340 (step S41).

Next, when the update PDF file is generated in step S40, the server controller 330 downloads the generated update PDF file to the second terminal device 200 or displays the generated update PDF file on a Web page (step S41). Furthermore, when the edit data is not registered in the registration file DB 343 (step S39/NO), the server controller 330 downloads the PDF file to the second terminal device 200 or displays the PDF file on the Web page (step S42).

Next, the server controller 330 determines whether PDF edit data has been received from the second terminal device 200 (step S43). When the server controller 330 receives the PDF edit data (step S43/YES), the server controller 330 registers the received PDF edit data in the record of the registration file DB 343 in which the PDF file selected in step S38 is registered (step S44).

Next, the server controller 330 determines whether the connection with the second terminal device 200 is disconnected (step S45). When the connection with the second terminal device 200 is not disconnected (step S45/NO), the server controller 330 determines whether another PDF file has been selected (step S46).

When another PDF file is selected (step S46/YES), the server controller 330 returns the process to step S39 and determines whether the edit data associated with the selected PDF file is registered in the registration file DB 343 (step S39). Further, when no other PDF file is selected (step S46/NO), the server controller 330 returns the process to the determination in step S43.

Further, when the connection with the second terminal device 200 is disconnected (step S45/YES), the server controller 330 deletes the edited PDF file stored in the server storage unit 340 from the server storage unit 340 (step S47), and this processing flow is ended.

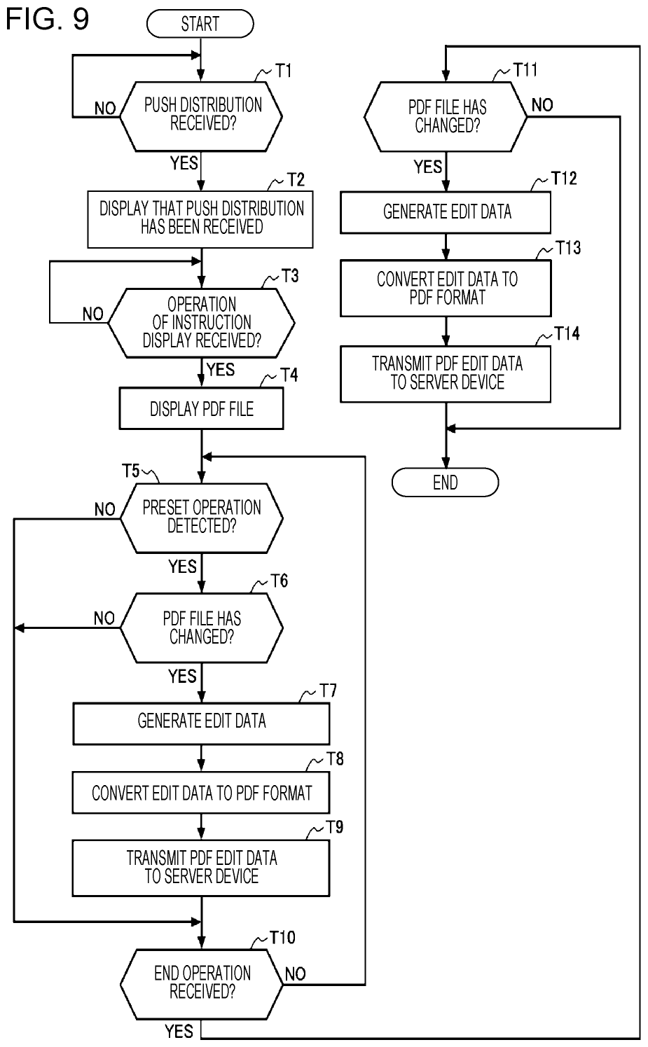

FIG. 9 is a flowchart showing the operation of the first terminal device 100 to which a PDF file is push distributed. The operation of the first controller 150 will be described with reference to the flowchart shown in FIG. 9. First, the first controller 150 determines whether push distribution of a PDF file has been received (step T1). When the first controller 150 has not received the push distribution of the PDF file (step T1/NO), the first controller 150 waits until the push distribution is received.

Upon receiving push distribution of the PDF file (step T1/YES), the first controller 150 displays on the touch panel 130 that the push distribution of the PDF file has been received (step T2).

Next, the first controller 150 determines whether an operation of an instruction to display the push distributed PDF file has been received (step T3). When the first controller 150 has not received an operation of an instruction to display of the push distributed PDF file (step T3/NO), the first controller 150 waits until the operation of the display instruction is received.

When the first controller 150 receives an operation of an instruction to display the push distributed PDF file (step T3/YES), the first controller 150 displays the push distributed PDF file on the touch panel 130 (step T4). Next, the first controller 150 determines whether a preset operation on the touch panel 130 is detected (step T5).

When the first controller 150 does not detect the preset operation on the touch panel 130 (step T5/NO), the first controller 150 advance the process to the determination in step T9. The determination in step T9 will be described later.

When the first controller 150 detects the preset operation on the touch panel 130 (step T5/YES), the first controller 150 determines whether the PDF file displayed on the touch panel 130 has been changed (step T6). The first controller 150 determines whether the PDF file displayed on the touch panel 130 has been changed by adding a handwritten character, a figure, a symbol, and the like, or adding a captured image and the like.

When there is no change in the PDF file (step T6/NO), the first controller 150 advance the process to the determination in step T9. Further, when the PDF file is changed (step T6/YES), the first controller 150 generates the edit data including the difference data, which is the difference between the PDF file before the change and the PDF file after the change, and the position information (step T7). The data format of the edit data is data in a proprietary format provided by the provider. The first controller 150 converts the data format of the generated edit data from the proprietary format provided by the provider to PDF to generate PDF edit data (step T8). The first controller 150 transmits the generated PDF edit data to the server device 300 (step T9).

Next, the first controller 150 determines whether an end operation to close the PDF file has been received (step T10). When the first controller 150 has not received the end operation (step T10/NO), the process returns to step T5.

When the first controller 150 receives the end operation to close the PDF file (step T10/YES), the first controller 150 determines whether there is a change in the PDF file (step T11). When there is no change in the PDF file (step T11/NO), the first controller 150 ends this processing flow.

When there is a change in the PDF file (step T11/YES), the first controller 150 generates edit data including the difference data that is the difference between the PDF file before the change and the PDF file after the change, and the position information and (step T12). The first controller 150 converts the data format of the generated edit data from the proprietary format provided by the provider to PDF to generate PDF edit data (step T13). The first controller 150 transmits the generated PDF edit data to the server device 300 (step T14), and ends this processing flow.

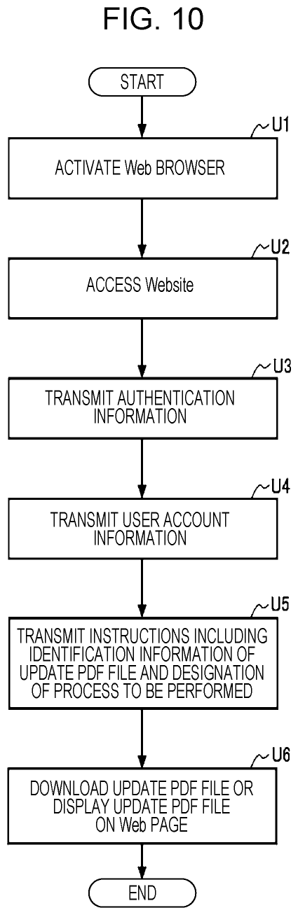

FIG. 10 is a flowchart showing the operation of the second terminal device 200 when viewing a PDF file registered in the server device 300. The operation of the second controller 250 will be described with reference to the flowchart shown in FIG. 10.

When receiving the operation to activate the Web browser, the second controller 250 activates the Web browser (step U1) and accesses the Website provided by the server device 300 (step U2).

When accessing the Website provided by the server device 300, the second controller 250 displays, on the display unit 230, the Web page provided by the server device 300. This Web page displays input fields for a user ID and a password. When the user ID and the password are input in the input fields and the confirm button (not shown) is pressed, the second controller 250 transmits the user ID and the password, which are authentication information, to the server device 300 (step U3).

When the authentication using the authentication information in the server device 300 is successful, the second controller 250 displays a Web page that is provided by the server device 300 and on which the input field for user account information is displayed on the display unit 230. When the user account information is input in the input field and the confirm button is pressed, the second controller 250 transmits the user account information to the server device 300 (step U4).

When the user account information is transmitted to the server device 300, the second controller 250 displays a Web page that is provided by the server device 300 and the list screen on which a list of PDF files and update PDF files associated with this user account information is displayed.

The user inputs selection of an update PDF file from the list of the list screen displayed on the Web page and the designation of the process to be performed on the update PDF file. The second controller 250 transmits an instruction including the identification information about the update PDF file and the designation of the process to be performed on the update PDF file to the server device 300 in accordance with the operation received by the operation unit 220 (step U5).

Upon receiving the instruction from the second terminal device 200, the server controller 330 displays the update PDF file on a Web page displayed on the display unit 230 of the second terminal device 200 for the update PDF file corresponding to the identification information in accordance with the received instruction. Furthermore, the server controller 330 causes the second terminal device 200 to download the update PDF file (step U6).

### 5. Other Aspects

The embodiments described above are preferred embodiments of the present disclosure. However, without being limited to the above-described embodiment, various modifications can be made without departing from the gist of the present disclosure. For example, the functional units of the first terminal device 100, the second terminal device 200, and the server device 300 shown in FIG. 1 indicate functional configurations, and the specific implementation form is not particularly limited. In other words, it is not necessarily necessary to implement hardware that corresponds to each functional unit individually, and it is of course possible to have a configuration in which one or more processors execute programs to implement the functions of a plurality of functional units. In addition, in the above embodiment, some of the functions implemented by software may be implemented by hardware, or some of the functions implemented by hardware may be implemented by software. In addition, specific detailed configurations of other parts of the first terminal device 100, the second terminal device 200, and the server device 300 can be changed in any manner without departing from the scope of the present disclosure.

Further, in the present embodiment described above, the description is made in which the first controller 150 generates edit data including the difference data and the position information every time a preset operation is detected, and transmits, to the server device 300, PDF edit data obtained by converting the data format of the generated edit data into PDF. Apart from this, the first controller 150 may transmit data including the PDF file and the edit data to the server device 300. At this time, the data format of the edit data transmitted by the first controller 150 to the server device 300 may be a proprietary format provided by the provider, or may be PDF edit data converted from the proprietary format provided by the provider to a PDF format.

The first controller 150 may convert the data format of the edit data into a PDF format, add the edit data in the PDF format to the PDF file to generate an update PDF file, and transmit only the generated update PDF file to the server device 300.

In the following, a case will be described in which the first controller 150 transmits edit data in the proprietary format provided by the provider to the server device 300. Upon receiving the data from the first terminal device 100, the server controller 330 registers the received data in the corresponding record of the registration file DB 343. When the data format of the edit data received from the first terminal device 100 is a proprietary format provided by the provider, the server controller 330 converts the edit data into a PDF format that can be viewed with the Web browser 261. The server controller 330 registers the generated edit data in the corresponding record of the registration file DB 343. That is, in addition to the PDF file, the edit data in PDF format and the edit data in the proprietary format provided by the provider are registered in the corresponding record of the registration file DB 343.

Further, the server controller 330 reads the corresponding PDF file from the server storage unit 340 and adds the converted edit data in the PDF format to the read PDF file to generate an update PDF file. Further, the server controller 330 converts the format of the PDF file read from the server storage unit 340 into a proprietary format provided by the provider. The server controller 330 updates the PDF file by adding edit data in the proprietary format provided by the provider to the PDF file converted into the proprietary format provided by the provider. The updated file is referred to as an update proprietary file. The update proprietary file corresponds to third data. The server controller 330 registers the update PDF file and the update proprietary file in the corresponding record of the registration file DB 343. In addition to the PDF file, the edit data in PDF format, the edit data in the proprietary format provided by the provider, the update PDF file, and the update proprietary file are further registered in the corresponding record of the registration file DB 343.

When a Website provided by the server device 300 is accessed by the Web browser 261 and a PDF file viewing request or a download request is received, the server controller 330 displays the update PDF file on the Web browser 261 that is a requester of the viewing request, or downloads the update PDF file to a requester of the download request.

Further, the terminal identification information to be registered in the user management DB 341 may be divided into primary and secondary information. The terminal identification information to be registered as primary information is identification information about the terminal device to which the uploaded PDF file is push distributed when the user account information and the PDF file are uploaded from the second terminal device 200. The terminal identification information to be registered as secondary information is identification information about the terminal device to which the PDF file and edit data is push distributed when data such as PDF edit data is received from the terminal device of the primary terminal identification information. This description will be made assuming that, for example, the identification information about the first terminal device 100 is registered as the primary terminal identification information, and, for example, the terminal identification information about the third terminal device (not shown) is registered as the secondary terminal identification information. The third terminal device is a terminal device other than the first terminal device 100 on which the application 165 is installed.

When the server controller 330 receives the PDF edit data from the first terminal device 100 to which the PDF file is push distributed and updates the corresponding record in the registration file DB 343, the server controller 330 acquires secondary terminal identification information, and push distributes the PDF file and the edit data in the proprietary format provided by the provider to the third terminal device corresponding to the acquired terminal identification information. Additionally, the server controller 330 may push distribute the update proprietary file to the terminal identification information.

Further, in the present embodiment described above, the second terminal device 200 executes the printer driver 263 to convert the document file to a PDF file, and transmits the converted PDF file to the server device 300. The second terminal device 200 may transmit a document file or an image file to the server device 300 without converting them into a PDF file. That is, a configuration may be used in which the document file and the image file are transmitted and received between the first terminal device 100, the second terminal device 200, and the server device 300.

Further, the processing units in the flowcharts shown in FIGS. 6, 7, and 8 are divided according to main processing content in order to facilitate understanding of the processing of the server device 300. The present disclosure is not limited by the method and the name of division in the processing units shown in the flowchart of FIGS. 6, 7 and 8. In addition, the processing by the server device 300 can be divided into more processing stages depending on the processing contents, or can be divided such that one processing unit includes more processes. Further, the order of processing in the flowcharts is not limited to the illustrated example. The same applies to the flowchart showing the operation of the first terminal device 100 shown in FIG. 9 and the flowchart showing the operation of the second terminal device 200 shown in FIG. 10.

Further, the first data may be uploaded from a terminal other than the second terminal, the terminal including the first terminal.

Furthermore, in the present embodiment described above, the editing content for the PDF file is transmitted from the first terminal device 100 to the server device 300, but the configuration may be such that record on the number of times of paper printing is performed by the operation on the first terminal device 100 and information about the output device, the number of times of viewing and the time of viewing on the first terminal device 100, the number of times of viewing and the number of times of file downloading, and the time of viewing on the second terminal device 200, and the like are transmitted to the server device 300, and are stored as the usage history of each user in the user management DB 341 and the registration file DB 343. By storing usage history of each user in the user management DB 341 and the registration file DB 343, the information management system 1 of the present disclosure can be utilized as a system for managing confidential information. For example, when information corresponding to confidential information is leaked, the route of the leak can be traced by searching usage history of each user. Therefore, it is possible to prevent the user from taking an action of leaking information or the like.

### 6. Summary of the Present Disclosure

The summary of the present disclosure is appended below.

### Supplementary Note 1

An information management system including a first terminal device, and a server device, wherein the first terminal device includes a first communication unit that acquires first data from the server device, an operation unit that receives an operation, and a first controller that transmits, when the operation unit receives an editing operation on the acquired first data, edit data corresponding to the editing operation to the server device, and wherein the server device includes a server communication unit that acquires the edit data from the first terminal device, a storage unit that stores the first data and the edit data in association with each other, and a server controller that provides a user with second data obtained by editing the first data stored in the storage unit in accordance with the edit data.

According to this configuration, when the first terminal device receives an editing operation on the first data acquired from the server device, the first terminal device transmits the edit data corresponding to the received editing operation to the server device. The server device stores the first data and the edit data in association with each other in the storage unit, and provides the user with the second data in which the first data is edited in accordance with the edit data. Therefore, user convenience can be improved.

### Supplementary Note 2

The information management system according to Supplementary Note 1, wherein the server controller provides a user with the generated second data to by transmitting the generated second data to a second terminal device.

According to this configuration, the server device generates the second data to transmit the generated second data to the second terminal device. Therefore, the second data is provided to the user by displaying the second data on the second terminal device without second terminal device generating the second data.

### Supplementary Note 3

The information management system according to Supplementary Note 2, wherein the storage unit continues to store the first data and the edit data even after the second data is transmitted.

According to this configuration, even after the second data is transmitted to the second terminal device, the storage unit of the server device continues to store the first data and the edit data. Therefore, it is possible to transmit the second data to the second terminal device again, or to transmit the second data to another terminal device other than the second terminal device.

### Supplementary Note 4

The information management system according to Supplementary Note 2 or 3, wherein the server controller deletes the second data before a connection between the second terminal device and the server device is terminated, or in response to a connection between the second terminal device and the server device being terminated.

According to this configuration, the second data is deleted before the connection between the second terminal device and the server device is terminated or in response to the connection between the second terminal device and the server device being terminated, so that it is possible to suppress an increase in the amount of data stored in the storage unit.

### Supplementary Note 5

The information management system according to any one of Supplementary Notes 1 to 4, wherein the storage unit stores the first data and the edit data as separate files.

According to this configuration, the first data and the edit data are stored as separate files. Therefore, when the first data or edit data are acquired, it is easy to acquire the first data or edit data.

### Supplementary Note 6

The information management system according to Supplementary Note 1, wherein the server controller transmits the first data and the edit data to a second terminal device, and the server controller causes the second terminal device to generate the second data to provide the generated second data to a user.

According to this configuration, the second terminal device generates the second data based on the first data and the edit data, so that it is possible to reduce the processing load on the server device.

### Supplementary Note 7

The information management system according to Supplementary Note 6, wherein the server controller causes a browser program of the second terminal device to generate the second data to provide the generated second data to a user.

According to this configuration, the browser program on the second terminal device generates the second data, so that there is no need to install a dedicated program on the second terminal device, and it is possible to reduce the processing load on the server device.

### Supplementary Note 8

The information management system according to Supplementary Note 1, wherein the first controller transmits the edit data including difference data indicating a difference between the first data and the second data to the server device.

According to this configuration, the edit data including the difference data is transmitted to the server device. Therefore, the amount of data transmitted to the server device can be reduced, and the amount of data stored by the server device can be reduced, compared to the data amount in a case where the first terminal device transmits the second data to the server device.

### Supplementary Note 9

The information management system according to Supplementary Note 8, wherein the difference data includes at least one of a text, a figure, and an image.

According to this configuration, the difference data including at least one of a text, a figure, and an image is transmitted from the first terminal device to the server device. Therefore, the server device can generate the second data including at least one of a text, a figure, and an image.

### Supplementary Note 10

The information management system according to Supplementary Note 1, further including a display unit, an operation unit, and a second controller that executes a Web browser, wherein the second controller executes the Web browser to display a Web page provided by the server device on the display unit, and when a request for viewing the second data is input to the Web page, transmits the request for viewing the second data to the server device, and wherein upon receiving the request for viewing the second data, the server controller displays the second data on the Web page.

According to this configuration, the second data is displayed on the Web page by inputting a request for viewing the second data on the Web page provided by the server device. Therefore, the second data can be displayed by the second terminal device executing the Web browser.

### Supplementary Note 11

The information management system according to Supplementary Note 10, wherein upon receiving the request for viewing the second data from the Web browser, the server controller generates the second data that is PDF data and displays the second data on the Web page.

According to this configuration, the second data that is PDF data is displayed on the Web page.

### Supplementary Note 12

The information management system according to Supplementary Note 10, wherein in response to the edit data being transmitted from the first terminal device, the server controller displays the second data updated based on the transmitted edit data on the Web browser.

According to this configuration, the Web browser displays the second data updated based on the edit data in response to the first terminal device transmitting the edit data to the server device. Therefore, user convenience can be improved.

### Supplementary Note 13

The information management system according to Supplementary Note 1, further including a second terminal device including a second communication unit and a second controller that transmits the first data to the server device, wherein upon receiving the first data from the second terminal device, the server controller stores the first data in the storage unit.

According to this configuration, the first data can be transmitted from the second terminal device to the server device, and the first data can be stored in the server device.

### Supplementary Note 14

The information management system according to Supplementary Note 13, wherein the first data is a PDF file generated by a printer driver.

According to this configuration, the PDF file generated by the printer driver can be stored in the server device.

### Supplementary Note 15

The information management system according to Supplementary Note 13 or 14, wherein the second terminal device converts a document file including at least one of a text, a figure, and a captured image into the first data.

According to this configuration, the document file including at least one of a text, a figure, and a captured image is converted into the first data. The converted first data is transmitted to the server device, so that the document file including at least one of a text, a figure, and a captured image can be registered as first data in the server device.

### Supplementary Note 16

The information management system according to Supplementary Note 1, further including a second terminal device including a second communication unit and a second controller that transmits the first data to the server device, wherein upon receiving the first data from the second terminal device, the server controller notifies the first terminal device of reception of the first data.

According to this configuration, when the second terminal device transmits the first data to the server device, the first terminal device is notified that the first data has been received. Therefore, it is possible to notify the user of the first terminal device that the server device has received the first data, and the user of the first terminal device can view the first data, and the first data can be transmitted to the first terminal device from the server device.

### Supplementary Note 17

The information management system according to any one of Supplementary Notes 1 to 16, wherein the first terminal device transmits the edit data to the server device in response to an operation in which a handwriting mode is turned off.

According to this configuration, upon receiving an operation in which a handwriting mode is turned off, the first terminal device transmits the edit data to the server device. Therefore, the edit data can be transmitted to the server device without performing an operation to transmit the edit data to the server device, and user convenience can be improved.

### Supplementary Note 18

The information management system according to any one of Supplementary Notes 1 to 17, wherein the first terminal device transmits the edit data to the server device in response to a predetermined time elapsing since contact between an indicator and a touch panel that is the operation unit was no longer detected.

According to this configuration, when a predetermined period of time has elapsed since contact between the indicator and the touch panel was no longer be detected, the edit data is transmitted from the first terminal device to the server device. Therefore, the edit data can be transmitted to the server device without performing an operation to transmit the edit data to the server device, and user convenience can be improved.

### Supplementary Note 19

A server device including a server communication unit that acquires, from a first terminal device, edit data corresponding to an editing operation performed by the first terminal device on first data, a storage unit that stores the first data and the edit data in association with each other, and a server controller that provides a user with second data obtained by editing the first data stored in the storage unit in accordance with the edit data.

According to this configuration, the server device acquires the edit data corresponding to the editing operation performed by the first terminal device, and provides the user with the second data obtained by editing the first data in accordance with the edit data. Therefore, user convenience can be improved.

### Supplementary Note 20

A non-transitory computer-readable storage medium storing a program, the program causing a terminal device to execute an acquisition function of acquiring, from a server, first data stored in a server and edit data corresponding to an editing operation performed by a first terminal device on the first data, and a presentation function of generating second data obtained by editing the first data in accordance with the edit data to present the generated second data to a user.

According to this configuration, the server device acquires the edit data corresponding to the editing operation performed by the first terminal device, and provides the user with the second data obtained by editing the first data in accordance with the edit data. Therefore, user convenience can be improved.

What is claimed is:

1. An information management system comprising:
a first terminal device; and
a server device, wherein
the first terminal device includes
a first communication unit that acquires first data from the server device,
an operation unit that receives an operation, and
a first controller that transmits, when the operation unit receives an editing operation on the acquired first data, edit data corresponding to the editing operation to the server device, and wherein
the server device includes
a server communication unit that acquires the edit data from the first terminal device,
a storage unit that stores the first data and the edit data in association with each other, and
a server controller that provides a user with second data obtained by editing the first data stored in the storage unit in accordance with the edit data.

2. The information management system according to claim 1, wherein the server controller provides a user with the generated second data to by transmitting the generated second data to a second terminal device.

3. The information management system according to claim 2, wherein the storage unit continues to store the first data and the edit data even after the second data is transmitted.

4. The information management system according to claim 3, wherein the server controller deletes the second data before a connection between the second terminal device and the server device is terminated, or in response to a connection between the second terminal device and the server device being terminated.

5. The information management system according to claim 1, wherein the storage unit stores the first data and the edit data as separate files.

6. The information management system according to claim 1, wherein
the server controller transmits the first data and the edit data to a second terminal device, and wherein
the server controller causes the second terminal device to generate the second data to provide the generated second data to a user.

7. The information management system according to claim 6, wherein the server controller causes a browser program of the second terminal device to generate the second data to provide the generated second data to a user.

8. The information management system according to claim 1, wherein the first controller transmits the edit data including difference data indicating a difference between the first data and the second data to the server device.

9. The information management system according to claim 8, wherein the difference data includes at least one of a text, a figure, and an image.

10. The information management system according to claim 1, further comprising:
a display unit;
an operation unit; and
a second controller that executes a Web browser, wherein
the second controller executes the Web browser to display a Web page provided by the server device on the display unit, and
when a request for viewing the second data is input to the Web page, transmits the request for viewing the second data to the server device, and wherein
upon receiving the request for viewing the second data, the server controller
displays the second data on the Web page.

11. The information management system according to claim 10, wherein upon receiving the request for viewing the second data from the Web browser, the server controller generates the second data that is PDF data and displays the second data on the Web page.

12. The information management system according to claim 10, wherein in response to the edit data being transmitted from the first terminal device, the server controller displays the second data updated based on the transmitted edit data on the Web browser.

13. The information management system according to claim 1, further comprising:
a second terminal device including
a second communication unit and
a second controller that transmits the first data to the server device, wherein
upon receiving the first data from the second terminal device, the server controller
stores the first data in the storage unit.

14. The information management system according to claim 13, wherein the first data is a PDF file generated by a printer driver.

15. The information management system according to claim 13, wherein the second terminal device converts a document file including at least one of a text, a figure, and a captured image into the first data.

16. The information management system according to claim 1, further comprising: a second terminal device including
a second communication unit and
a second controller that transmits the first data to the server device, wherein
upon receiving the first data from the second terminal device, the server controller
notifies the first terminal device of reception of the first data.

17. The information management system according to claim 1, wherein the first terminal device transmits the edit data to the server device in response to an operation in which a handwriting mode is turned off.

18. The information management system according to claim 1, wherein the first terminal device transmits the edit data to the server device in response to a predetermined time elapsing since contact between an indicator and a touch panel that is the operation unit was no longer detected.

19. A server device comprising:
a server communication unit that acquires, from a first terminal device, edit data corresponding to an editing operation performed by the first terminal device on first data;
a storage unit that stores the first data and the edit data in association with each other; and
a server controller that provides a user with second data obtained by editing the first data stored in the storage unit in accordance with the edit data.

20. A non-transitory computer-readable storage medium storing a program, the program causing a terminal device to execute:
an acquisition function of acquiring, from a server, first data stored in a server and edit data corresponding to an editing operation performed by a first terminal device on the first data; and
a presentation function of generating second data obtained by editing the first data in accordance with the edit data to present the generated second data to a user.
